(19) United States
(12) Patent Application Publication
(10) Pub. No.: US 2010/0225807 A1
(43) Pub. Date: Sep. 9, 2010

(54) Closed-Captioning System and Method

(76) Inventor: Mark Gilmore Mears, Zionsville, IN (US)

Correspondence Address: Robert D. Shedd, Patent Operations;THOMSON Licensing LLC, P.O. Box 5312, Princeton, NJ, 08543-5312, US

(21) Appl. No.: 12/223,144

(22) PCT Filed: Jan. 26, 2006
(86) PCT No.: PCT/US2006/003185

§ 371 Date: Jul. 23, 2008

(51) Int. Cl. H04N 7/00

(52) U.S. Cl. 348/468; 348/E07.001

(57) ABSTRACT

An apparatus and method for processing closed caption information associated with a video program, including: identifying a keyword in the closed caption information; determining whether the identified keyword has an icon associated therewith; and displaying the icon in place of the keyword in the closed caption display.

### FIELD OF THE INVENTION

This invention relates to receivers having circuitry for receiving and processing closed caption data.

### BACKGROUND OF THE INVENTION

Closed-caption systems aid the hearing-impaired in enjoying video programs (sometime referred to as “programs” or “programming”). In such a system, text corresponding to words spoken, and sometimes other sounds, in a program are transmitted with the picture and sound information from the broadcast transmitter. The closed-caption text, or content, is typically displayed at the bottom of the screen in a manner similar to the way in which motion picture subtitles are displayed so that a hearing-impaired viewer may better understand the television program. Closed caption systems also enable a user to view the spoken contents of a program without disturbing someone else in the vicinity of the television.

In a closed-caption system, closed-caption text is conventionally transmitted a few characters at a time during the vertical blanking interval on television line 21. A closed-caption decoder captures the closed caption content on line 21, and displays it via on-screen display circuitry. In a digital television environment, the closed caption data may be transmitted in designated transport packets multiplexed with the audio and video packets of the associated program. Conventionally, the closed caption text is display in the same manner for all of the programs, and the text associated with the program, on a television display, that is, using a particular font, size, color, etc. It may be desirable to display the closed caption data in different ways to facilitate user understanding and enjoyment of the displayed data.

### SUMMARY OF THE INVENTION

The present invention recognizes that icons may be more readily understood and read from a closed caption display than text. In that regard, the present invention provides for substituting icons for keywords in the closed caption display. In particular, the present invention is a method and apparatus for processing closed caption information associated with a video program, including: identifying a keyword in the closed caption information; determining whether an identified keyword has an icon associated therewith; and generating a display signal having the icon in place of the keyword in the closed caption display. In a further embodiment, the user may select one of a plurality of correspondence tables, each of the tables having different correspondence of keywords and icons. In a further embodiment, the user may build a personalized correspondence table by selecting a specific icon for selected keywords. In a further embodiment, the invention provides an interface that enables the user to selectively enable or disable the icon display feature.

### BRIEF DESCRIPTION OF THE FIGURES

Understanding of the present invention will be facilitated by consideration of the following detailed description of the preferred embodiments of the present invention taken in conjunction with the accompanying drawings, wherein like numerals refer to like parts and:

FIG. 1 illustrates a block diagram of a television receiver; and

FIG. 2 illustrates a flow diagram of a process according to an aspect of the present invention.

### DETAILED DESCRIPTION OF THE PREFERRED EMBODIMENTS

It is to be understood that the figures and descriptions of the present invention have been simplified to illustrate elements that are relevant for a clear understanding of the present invention, while eliminating, for purposes of clarity, many other elements found in typical television programming broadcast, reception and presentation systems. Those of ordinary skill in the art will recognize that other elements are desirable and/or required in order to implement the present invention. However, because such elements are well known in the art, a detailed discussion of such elements is not provided herein.

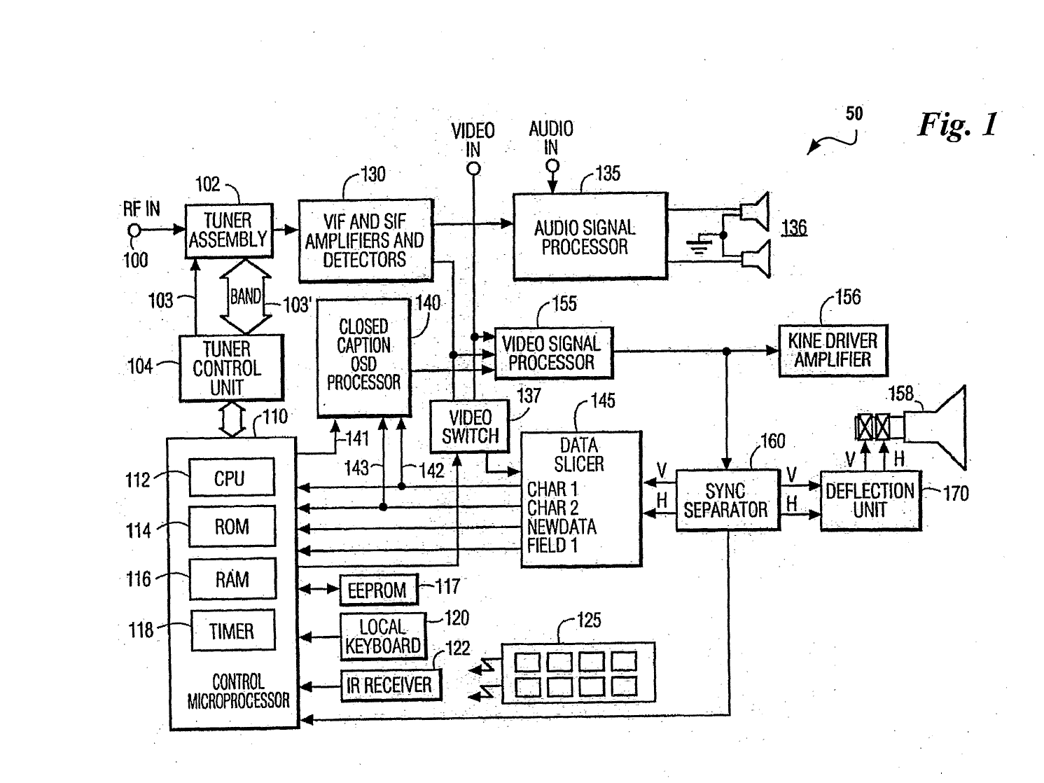

Referring to FIG. 1, there is shown a block diagram of a television receiver 50. U.S. Pat. No. 5,428,400, assigned to the assignee hereof, the entire disclosure of which is hereby incorporated by reference herein, discloses the configuration and operation of such a receiver. For non-limiting purposes of explanation though, television receiver 50 includes an RF input terminal 100 which receives radio frequency (RF) signals and applies them to a tuner assembly 102. Tuner assembly 102 selects and amplifies a particular RF signal under control of a tuner controller 104, which provides a tuning voltage via a wire 103, and band-switching signals via signal lines represented by the broad double-ended arrow 103′, to tuner assembly 102.

Tuner assembly 102 down-converts the received RF signal to an intermediate frequency (IF) signal, and provides the IF signal as an output to video (VIF) and sound (SIF) amplifier and detector unit 130. VIF/SIF amplifier and detector unit 130 amplifies the IF signal applied to its input terminal and detects the video and audio information contained therein. The detected video information is applied at one input of a video processor unit 155. The detected audio signal is applied to an audio processor 135 for processing and amplification before being applied to a speaker assembly 136.

Tuner controller 104 generates the tuning voltage and band-switching signals in response to control signals applied from a system controller, microcomputer or microprocessor 110. Controller 110 may take the form of an integrated circuit especially manufactured for that specific purpose (i.e., an application specific integrated circuit “ASIC”). Controller 110 receives user-initiated commands from an infrared (IR) receiver 122 and/or from a “local” keyboard 120 mounted on the television receiver itself. IR receiver 122 receives IR transmissions from remote control transmitter 125. Controller 110 includes a central processing unit (CPU) 112, a program or code memory (ROM) 114, and stores channel-related data in a random-access memory (RAM) 116. RAM 116 may be either internal to, or external to, microprocessor 110, and may be of either the volatile or non-volatile type. The term “RAM” is also intended to include electrically-erasable programmable read only memory (EEPROM) 117. One skilled in the art will recognize that if volatile memory is utilized, that it may be desirable to use a suitable form of standby power to preserve its contents when the receiver is turned off. Controller 110 also includes a timer 118.

Microcomputer (or controller) 110 generates a control signal for causing tuner control unit 104 to control tuner 102 to select a particular RF signal, in response to user-entered control signals from local keyboard 120 and/or infrared (IR) receiver 122.

Tuner 102 produces a signal at an intermediate frequency (IF) and applies it to a processing unit 130 including a video IF (VIF) amplifying stage, an AFT circuit, a video detector and a sound IF (SIF) amplifying stage. Processing unit 130 produces a first baseband composite video signal (TV), and a sound carrier signal. The sound carrier signal is applied to audio signal processor unit 135, which includes an audio detector and may include a stereo decoder. Audio signal processor unit 135 produces a first baseband audio signal and applies it to a speaker unit 136. Second baseband composite video signals and second baseband audio signals may be applied to VIDEO IN and AUDIO IN terminals from an external source.

The first and second baseband video signals (TV) are coupled to video processor unit 155 (having a selection circuit not shown). Electrically-erasable programmable read only memory (EEPROM) 117 is coupled to controller 110, and serves as a non-volatile storage element for storing auto programming channel data, and user-entered channel data.

The processed video signal, at the output of video signal processor unit 155, is applied to a Kine Driver Amplifier 156 for amplification and then applied to the guns of a color picture tube assembly 158 for display. The processed video signal at the output of video signal processor unit 155, is also applied to a Sync Separator unit 160 for separation of horizontal and vertical drive signals which are in turn applied to a deflection unit 170. The output signals from deflection unit 170 are applied to deflection coils of picture tube assembly 158 for controlling the deflection of its electron beam.

A data slicer 145 receives closed caption data at a first input from VIF/SIF amplifier and detector unit 130, and at a second input from the VIDEO IN terminal via a video switch 137 that selects the proper source of closed-caption data under control of controller 110. Data slicer 145 supplies closed-caption data to closed caption processor 140 via lines 142 and 143. Data slicer 145 supplies closed-caption status data (NEWDATA, FIELD 1) to controller 110. Under control of controller 110, via control line 141, the closed caption processor 140 generates character signals, and applies them to an input of video signal processor 155, for inclusion in the processed video signal. Processor 140 and/or data slicer 145 may be included in controller 110. Although the embodiment of FIG. 1 is in the environment of a receiver having a cathode ray tube, it is clear that the principles of this invention are applicable to other types of receiver without a display, such as a set top box, which is able to receive, process, and provide closed caption data displays. Further, the invention is also applicable to receiver having different types of displays, such as, but not limited to, LCD, plasma, DLP, and LCOS.

As will be understood by those possessing an ordinary skill in the pertinent arts, the closed caption information may be received during the vertical blanking interval on television line 21 and/or as at least a portion of another data stream. Information related to closed caption services may also be provided using, for example, extended data services (XDS) transmitted in accordance with EIA/CEA 608B. In the digital television environment the closed caption data may be received in designated transport packets multiplexed with the video and audio packets. Multiplexing and de-multiplexing of video, audio, closed-captioning and/or other data is known in the pertinent arts, and described, for example, in U.S. Pat. No. 5,867,207, issued Feb. 2, 1999 to the assignee hereof, the entire disclosure of which is hereby incorporated by reference herein.

According to an aspect of the present invention, select closed caption content, or closed caption text, may be replaced with icons. “Icon”, as used herein, generally refers to a small graphic, picture or character. The icons may optionally be animated.

The 1999 paper entitled “Time Spent Viewing Captions On Television Programs (#133)”, by Carl Jensema, Ramalinga Sarma Danturthi and Robert Burch, reports on eye movements of 23 deaf subjects, ages 14 to 61, while they watched captioned television programs. It reports that viewers in the study spent about 84 percent (84%) of their television viewing time looking at the program's captions, about 14% of the viewing time viewing the actual video picture, and about 2% of the time off of the video. According to an aspect of the invention, time spent watching the programming may be increased at the cost of time spent viewing captions.

It is believed that graphically representing information allows for faster recognition of that information. Thus, according to an aspect of the present invention, it is believed that graphically representing information in captions allows more time for a user's eyes to be on the programming rather than the captions. It is believed this should prove helpful to all viewers, regardless of whether they are hearing-challenged. The graphical content may be introduced by replacing select caption text (such as text that is repetitively used) with icons (which may optionally be animated). For example, commonly used words may be replaced with associated icons indicative of the replaced words. “Laughter” may be replaced by an icon of a face laughing, while “applause” may be replaced by an icon of two hands clapping, for example. By way of further non-limiting example, when the word “whispering” is detected in a digital caption, an icon associated with and indicative of whispering (e.g., a profile of a person's head with hand put to side of mouth) may be displayed instead of the word “whispering”. Accordingly, faster (and potentially more entertaining) recognition of the information conveyed in digital captions may be achieved, thus allowing more time for a user's eyes to be on the associated programming rather than the captions. In effect, a caption “short-hand” may be presented to viewers.

According to an aspect of the present invention, such short-hand may be particularly well-suited for use in the common words, such as common “non-speech information” (NSI). NSI is a term to describe aspects of the sound track, other than spoken words, that convey information about plot, humor, mood or meaning of a spoken passage, e.g., “laughter” and “applause”. Of course, other words, such as spoken words, may also be converted to icons.

The inserted icons may, but need not, be complex in nature. For example, in the case of laughter, a simple “emoticon” with eyes closed and mouth open in a half-moon shape may be used. Alternatively, more complex icons, including animated icons, may be used. Either way, inclusion of such icons, should allow faster (and possibly more entertaining) recognition of information conveyed in digital captions, thus allowing more time for the eyes to be on the programming video content rather than the digital captions. In effect, such a digital caption “short-hand” may ultimately prove useful to many viewers, whether they are hearing-challenged or not.

According to an aspect of the present invention, when a keyword is detected in caption text, the device (e.g., TV or receiver) replaces the text with an icon stored in memory. This inserted graphic may take the form of a “character” in the closed captioning font that looks like an icon (much like how the conventional Wingdings font is really just a font where all characters are icons). The correspondence between the keyword and the icon may be associated based on a default correspondence table. Alternatively, there may be a plurality of correspondence tables provided, wherein the user is able to select a particular correspondence table based on the user's own preference. The correspondence between the keywords and the icons may differ based on the appearance of the icon, e.g., color, size, etc., or the actual icons that correspond to the keywords may be different. Alternatively, the device may allow the user to correlate a specific keyword with a specific icon. In that case, the display would provide a listing of specific keywords, and a listing of the available icons, wherein the user is able, using known user interface/menu methods, to specify the display of a specific icon for a particular keyword.

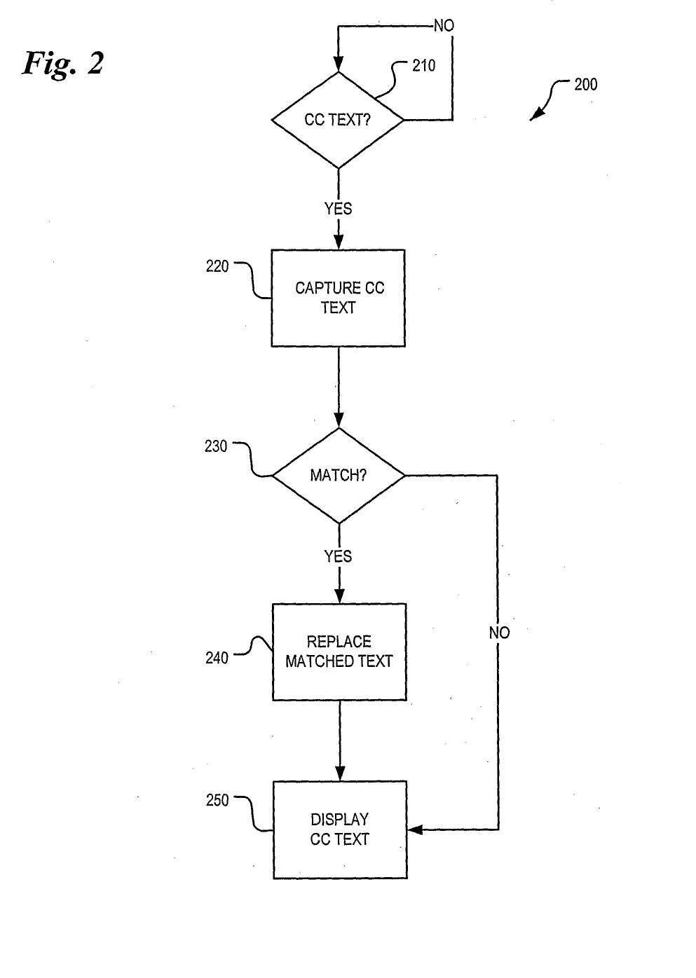

Referring now to FIG. 2 in addition to FIG. 1, there is shown a process flow 200 according to the second aspect of the present invention. Process 200 is suitable for introducing graphical representations of select text content into the closed captioning content. Process 200 may be embodied in a plurality of CPU 112 executable instructions (e.g., a program) being stored in memory 114, 116, 117. Process flow 200 begins with determining whether there is unprocessed closed caption text available (step 210). When unprocessed closed caption content is determined to be present (step 210), that closed caption content is captured (step 220). The captured content is compared to known text patterns to be replaced (step 230). This may be accomplished using CPU 112 and a lookup table or database, for example. The lookup table may include data indicative of information akin to that shown in Table 1.

TABLE 1

| Text | Replacement |
|---|---|
| Laughter | Smiling face icon |
| Applause | hands clapping icon |

If no match is found (step 230), conventional closed caption processing may be used (step 250). If a match is found (step 230), the matching text may be replaced with the replacement character or icon (step 240). The modified closed caption text may then be processed conventionally (step 250).

A library of icons may be pre-recorded in memory 114 or 117. One or more lookup tables or databases may be used to associate select text strings with select ones of pre-recorded icons. Such a lookup table or database may be pre-configured and/or user customizable. For example, a user may be permitted to customize the contents of such a lookup table or database in a conventional manner, e.g., using keyboard 122 and/or remote control 125. In such a manner, a user may be permitted to associate select icons with select text strings.

In an alternative embodiment, the user may be provided with an option, via a set up menu or the like, to enable or disable the use of icons in the closed caption display. This feature enables the icon displays to be selectively enabled or disabled by the user based on individual preference. This option may be enabled with the selection of a correspondence table mentioned above.

It will be apparent to those skilled in the art that modifications and variations may be made in the apparatus and process of the present invention without departing from the spirit or scope of the invention. It is intended that the present invention cover the modification and variations of this invention provided they come within the scope of the appended claims and their equivalents.

1. A method for processing closed caption information associated with a video program, comprising:
identifying a keyword in the closed caption information;
determining whether an identified keyword has an icon associated therewith; and
generating a closed caption display signal having the icon in place of the keyword in the closed caption display in response to the determination of the associated icon.

2. The method of claim 1, further comprising providing an interface for allowing a user to select one of a plurality of correspondence tables that associate keywords with icons, wherein the determining step is performed using the selected correspondence table.

3. The method of claim 1, further comprising providing an interface for allowing a user to enable or disable the icon display, wherein the steps of identifying, determining and generating are performed in response to the icon display being enabled.

4. The method of claim 1, further comprising providing an interface for allowing a user to select a particular icon to be associated with a selected keyword.

5. The method of claim 1, wherein the keyword is indicative of non-speech information.

6. The method of claim 1, further comprising storing a plurality of icons in a memory.

7. The method of claim 4, further comprising storing keywords associated with said icons in said memory.

8. An apparatus comprising:
a memory storing icons each corresponding to an associated at least one keyword;
a receiver for receiving closed caption content; and
a processor operatively coupled to the memory and receiver, the processor operative to identify a keyword in the closed caption content, determine whether the identified keyword has an associated icon, and generating a closed caption signal having the icon in place of the keyword in the closed caption display in response to the determination of the icon.

9. The apparatus of claim 8, wherein the processor further provides an interface for allowing a user to select one of a plurality of correspondence tables that associate keywords with icons, wherein the processor determines the associated icon using the selected correspondence table.

10. The apparatus of claim 8, wherein the processor further provides an interface for allowing a user to enable or disable the icon display, wherein the processor generates the closed caption signal having the icon in response to the icon display being enabled.

11. The apparatus of claim 8, wherein the processor further provides an interface for allowing a user to select a particular icon to be associated with a selected keyword.

12. The apparatus of claim 11, further comprising data indicative of user associations of said icons with said keywords being stored in the memory.

13. The apparatus of claim 8, wherein at least one of said keywords is indicative of non-speech information.
